(19) United States
(12) Patent Application Publication
(10) Pub. No.: US 2004/0192139 A1
(43) Pub. Date: Sep. 30, 2004

(54) Cover layer for engine compartment lining

(75) Inventors: August Torrents Pallach, Barcelona (ES); Charles Rodriguez, Barcelona (ES); Llorenc Farre Toran, Barcelona (ES)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/804,556

(22) Filed: Mar. 19, 2004

(30) Foreign Application Priority Data
Mar. 22, 2003 (DE) DE 103 12 817.4

(51) Int. Cl. B32B 27/12

(52) U.S. Cl. 442/327

(57) ABSTRACT

A cover layer for an engine compartment lining includes at least one binder-bonded nonwoven layer. The nonwoven layer is bonded using a binder having a thermoplastic behavior in the temperature range of 20° to 200° C. and a thermosetting behavior above 200° C. Also provided is a method for manufacturing the cover layer in which staple fibers having a length of 20 mm to 200 mm and a fiber count of 0.8 to 40 decitex are combined to form a nonwoven having a mass per unit area of 10 g/m² to 200 g/m². The nonwoven is then impregnated using the binder.

Priority is claimed to German Patent Application No. DE 103 12 817.4, filed on Mar. 22, 2003, the entire disclosure of which is incorporated by reference herein.

### BACKGROUND OF THE INVENTION

The present invention relates to a cover layer for engine compartment lining made of at least one binder-bonded nonwoven layer.

Engine compartment linings are used for the acoustic insulation of engine noises. Multi-layered materials which are used in engine compartment linings are known from International Patent Publication No. WO 02/053373. A substrate layer is formed here by impregnating or coating a fabric or a nonwoven made of inorganic fibers, or a paper using a resin compound which contains loess as an inorganic filler, the resin being a thermally curing resin selected from the group including phenolic resins, modified phenolic resins, modified phenol-urea resins, melamine resins, and modified melamine resins, the substrate layer having a backside layer made of aluminum or a galvanized steel plate.

A flame retardant, resin-bonded nonwoven in which the nonwoven is impregnated using a resin emulsion and a phosphorous-based flame retardant is known from Japanese Patent document JP 2002/004164. The nonwoven here is to be made of flame retardant rayon fibers, produced in mixed spinning, and flame retardant fibers made of partly carbonized normal rayon fibers and/or polyacrylonitrile fibers.

In addition, a cover layer for hot-melt shaping is known from Japanese Patent document JP 02/070428 in which, on the surface of a nonwoven made of polyester fibers and carbon fibers, a styrene resin is copolymerized and shaped by hot pressing.

Mats, made of phenolic resin-impregnated reclaimed cotton which is covered on the subsequently visible side with a nonwoven dyed black, are predominantly used as engine compartment lining. In addition to covering the reclaimed cotton, the nonwoven must be fluid repellent against various fluids such as water, gasoline, diesel, brake fluid, engine oil, and flame retardant in some places. Bonding with the reclaimed cotton is established by using adhesive media such as PE powder, copolymer PES, copolymer, PA, melamine resins, and phenolic resins which are fixed on the backside of the nonwoven. The composite is shaped in heated presses over 60-120 seconds at 200°-230° C.

Binder-bonded and needle-punched nonwovens are used which, in a second process step, are normally made flame-retardant and fluid-repellent using an impregnation method and which, in one step, are coated on the backside with the adhesive medium by powdering or printing. Due to economic reasons, binder-bonded nonwovens are normally preferred which, however, are frequently torn when deformed into deeper shapes and which must then be replaced at higher costs by the needle-punched nonwovens.

The automobile industry requires a material for the cover layer of the engine compartment lining which shows very high three-dimensional thermal shapability above 200° C. and is provided with flame retardant, as well as fluid-repellent, properties and which has great thermal bonding capability vis-à-vis the underlying material which is mostly made of inexpensive reclaimed wool; these properties should be provided without an additional method step.

### BRIEF SUMMARY OF THE INVENTION

An object of the present invention is to develop a binder-bonded nonwoven which, as is the case with needle-punched nonwovens, is suited for deeper shapes and which, at the same time, can be manufactured substantially more cost-efficiently through integration of flame-retardant and fluid-repellent properties into the base manufacture of the nonwoven.

The present invention provides a cover layer, composed of at least one binder-bonded nonwoven layer, bonded by a binder which has a thermoplastic behavior in the temperature range of 20° to 200° C. and a thermosetting behavior above 200° C. These behaviors are achieved via curingly crosslinking the binder. The nonwoven is advantageously bonded using a binder which condenses upon crosslinking and which only pre-crosslinks at a temperature of up to 200° C. and cures at a temperature above 200° C. The binder is selected here from the group composed of the acrylic acid copolymers and ter-polymers with styrene, butadiene, and/or acrylonitrile, preferably from the group composed of the acrylic acid copolymers and ter-polymers with styrene. In addition, the binder may contain flame retardant agents, water repellent agents, and/or oil repellent agents. A halogen-free and heavy metal-free phosphorous compound containing nitrogen is preferably present as a flame retardant. A phosphonic acid derivative is preferred which has an elemental content of ≧10 wt. % of nitrogen and ≧5 wt. % of phosphorous and shows high synergism. No hygroscopic behavior of the flame retardant and no softening effect on the binder have been observed. The nonwoven itself is made of rayon fibers, polyester fibers, cellulose fibers, polyamide fibers, polyolefine fibers, and/or pre-oxidized polyacrylonitrile fibers. The cover layer has a mass per unit area of 40 g/m² to 200 g/m², the weight ratio between the fibers employed per square meter and the binder employed per square meter being in the range of 0.5:1 to 2:0.5. For bonding with the underlayers, the nonwoven is coated on one side with a hot-setting adhesive made of polyethylene resins, copolyester resins, copolyamide resins, melamine resins, and/or phenolic resins.

In addition, the present invention relates to a method in which staple fibers having a length of 20 mm to 200 mm and a fiber count of 0.8 decitex to 40 decitex are combined to form a nonwoven having a mass per unit area of 10 g/m² to 200 g/m² and are impregnated using a binder which has a thermoplastic behavior in the temperature range of 20° to 200° C. and a thermosetting behavior above 200° C. The binder is applied in the form of foam. The nonwoven formation takes place in such a way that the ratio between the flexibility across the machine direction (cross direction CD) and the flexibility in the machine direction (machine direction MD) is in the range of 1:4 to 2:1. A hot-setting adhesive is subsequently applied to the nonwoven layer in a quantity which amounts to at least 10% of the base material composed of nonwoven, binder and, optionally, flame retardants, water repellents, and/or oil repellents.

A main advantage of the cover layer according to the present invention lies in the simplified manufacturing process where staple fibers, composed of white fibers and spun-dyed black fibers, are piled randomly using a carding process. The resulting nonwoven may be heavily oriented in the machine direction. Subsequently, impregnation takes place using a binder mixture in the form of foam which penetrates the nonwoven and, due to the complete wetting of the nonwoven, ensures the absorption of the binder. The selection of the binder is essential since it has two different phases of plastic behavior. First, a thermoplastic behavior in the range of room temperature up to 195° C., and second, a phase, which is achieved by complete curing of the binder due to a thermosetting behavior above 200° C. A further additive of the binding system are flame retardants, fluoric resins and, optionally, pigments in order to lend flame retardant and fluid-repellent properties, as well as uniform black coloring to the cover layer. Drying is performed at a temperature below 200° C. A nonwoven which has a thermoplastic character and a thermal binding capability is the result of these process conditions. The nonwoven is coated using a hot-setting adhesive in a final manufacturing step. The hot-setting adhesive, made of a polyolefin polymer for example, improves the bonding of the cover material with the reclaimed wool material after the thermal shaping at temperatures higher than 200° C. In contrast to the cover materials used previously, no preference is required with respect to the orientation of the nonwoven fabric prior to bonding with the reclaimed wool material in order to achieve three-dimensionally stable shapability. While traditional binder bonded nonwovens for the cover layer of engine compartment linings had to be used always transversely to the machine direction, this is no longer necessary. Engine compartment linings manufactured using the cover layer according to the present invention show a very good three-dimensional shapability above 200° C. No delamination of the shaped components occurs. The components have a very good thermal dimensional stability and do not show any shrinkage. The cover layer has a highly effective flame retardant property prior to and after thermal shaping at temperatures above 200° C. and a permanent water-repellent and oil-repellent property. By using the proposed manufacturing method, costs are reduced since a separate step for applying flame retardants and fluid repellents may be omitted.

### BRIEF DESCRIPTION OF THE DRAWING

The following drawing is illustrative of embodiments of the invention and are not meant to limit the scope of the invention as encompassed by the claims:

FIG. 1 is a flowchart displaying a method for manufacturing the cover layer of the present invention.

### DETAILED DESCRIPTION OF THE PREFERRED EMBODIMENTS

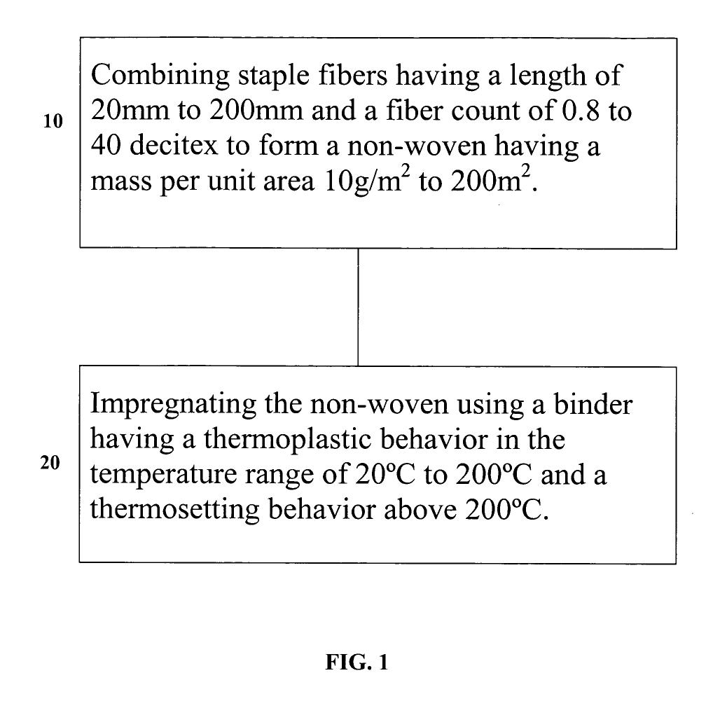

As shown in FIG. 1, the present invention includes a method having a first step 10 in which staple fibers having a length of 20 mm to 200 mm and a fiber count of 0.8 to 40 decitex are combined to form a nonwoven having a mass per unit area of 10 g/m² to 200 g/m². In a further step 20, the nonwoven is impregnated using a binder which has a thermoplastic behavior in the temperature range of 20° C. to 200° C. and a thermosetting behavior above 200° C.

The present invention is explained in greater detail in the following based upon three examples:

### EXAMPLE NO. 1

Using white and black spun-dyed low-strength polyester fibers having a fiber length of 60 mm and a fiber count of 3.3 decitex, a nonwoven having a mass per unit area of 35 g/m² is transversely formed, reorientation of the fibers taking place by increasing the speed, the ratio between the flexibility across the machine direction and the flexibility in the machine direction (cd/md) being approximately 2.0:1. The nonwoven is impregnated using binder foam composed of acrylic acid copolymer or ter-polymers with styrene, butadiene, and/or acrylonitrile resulting in a solids content of approximately 35 g/m². Drying takes place using hot air at 200° C., curing of the binder being avoided. The bonded nonwoven is subsequently coated using a hot-melt adhesive powder which is sintered to the nonwoven and melted. In a three-dimensional shaping process at temperatures higher than 200° C., the finished cover layer is attached to a substrate made of reclaimed wool, for example. Shaping takes place at a pressure of more than 200 bar/cm² over a period of 60 seconds to 90 seconds. The shaped components, produced by using the cover layer according to the present invention, are perfectly covered by the cover layer and also adhere to the sharp folds of the component without cracks and delamination. The edges may be cleanly cut.

### EXAMPLE NO. 2

Using 60 wt. % of white or black spun-dyed low-strength polyester fibers having a fiber length of 60 mm and a fiber count of 3.3 decitex and using 40 wt. % of white or black spun-dyed viscose fibers having a fiber length of 60 mm and a fiber lattice count of 3.3 decitex, a nonwoven of 40 g/m² is produced in a transverse configuration, reorientation of the fibers taking place by increasing the speed and the flexibility properties, the flexibility ratio cd/md being 2:1. Using a binder, composed of a thermally crosslinking co-polymer made of styrene and acrylic acid and having a solids content of 40 g/m², the nonwoven is impregnated and dried using hot air at 180° C., so that complete curing of the binder is avoided. Finally, as described in example no. 1, a hot-melt adhesive is applied.

### EXAMPLE NO. 3

Using 60 wt. % of black spun-dyed polyester fibers having a fiber length of 40 mm and a fiber count of 1.7 decitex and using 40 wt. % of a black spun-dyed viscose fiber having a fiber length of 40 mm and a fiber count of 1.7 decitex, a nonwoven of 80 g/m² is produced in a transverse configuration, a reorientation of the fibers taking place by increasing the speed, the flexibility ratio cd/md being 2:1. The nonwoven is impregnated using a binder mixture having a solids content of 69 g/m². Drying takes place by using hot air below 200° C., so that complete curing of the binder is avoided. A polyolefin powder as the hot-melt adhesive is applied and sintered to one side of the cover nonwoven, the quantity of the adhesive representing at least 10 wt. % of the base material.

The flameproof properties and repellence according to the DIN 75200 and DIN 53906 standards of the cover layers described in Examples 1 through 3 are compiled in Table 1.

TABLE 1

| | Flameproof Properties | Repellence according |
|---|---|---|
| Examples | DIN 75200 | to DIN 53906 |
| 1 | 0.0 mm/60 s | <50 cm² |
| 2 | 0.0 mm/60 s | <50 cm² |
| 3 | 0.0 mm/60 s | <50 cm² |

What is claimed is:

1. A cover layer for engine compartment lining comprising:
at least one binder-bonded nonwoven layer, the nonwoven layer being bonded using a binder having a thermoplastic behavior in the temperature range of 20° to 200° C. and a thermosetting behavior above 200° C.

2. The cover layer as recited in claim 1, wherein the binder is capable of condensing upon crosslinking and being pre-crosslinked at a temperature of up to 200° C. and cured at a temperature above 200° C.

3. The cover layer as recited in claim 1, wherein the binder is selected from the group of the acrylic acid copolymers or ter-polymers with styrene, butadiene, and/or acrylonitrile.

4. The cover layer as recited in claim 3, wherein the binder is selected from the group of the acrylic acid copolymers with styrene.

5. The cover layer as recited in claim 1, wherein the binder contains flame retardant agents, water repellent agents, and/or oil repellent agents.

6. The cover layer as recited in claim 1, wherein the nonwoven layer includes halogen-free and heavy metal-free phosphorous compounds containing nitrogen as a flame retardant.

7. The cover layer as recited in claim 6, wherein the flame retardant is a nitrogen-containing phosphonic acid derivative having an elemental content of ≧10 wt. % of nitrogen and ≧5 wt. % of phosphorous.

8. The cover layer as recited in claim 1, wherein the nonwoven layer includes rayon fibers, polyester fibers, cellulose fibers, polyamide fibers, polyolefine fibers, and/or pre-oxidized polyacrylonitrile fibers.

9. The cover layer as recited in claim 1, wherein the cover layer has a mass per unit area of 20 g/m² to 200 g/m², and the nonwoven layer includes fibers in a weight ratio between the fibers employed per square meter and the binder employed per square meter being in the range of 0.5:1 to 2:0.5.

10. The cover layer as recited in claim 1, further comprising a coating on one side of the nonwoven layer, the coating including a hot-setting adhesive made of a polyolefin resin, polyester resin, phenolic resin, or melamine resin.

11. A method for manufacturing a cover layer as recited in claim 1 the method comprising the steps of:
combining staple fibers having a length of 20 mm to 200 mm and a fiber count of 0.8 to 40 decitex to form a nonwoven having a mass per unit area of 10 g/m² to 200 g/m²; and
impregnating the non-woven using a binder which has a thermoplastic behavior in the temperature range of 20° to 200° C. and a thermosetting behavior above 200° C.

12. The method as recited in claim 11, wherein the binder is applied in the form of foam.

13. The method as recited in claim 11, wherein the formation of the nonwoven takes place in such a way that a ratio of the flexibility across the machine direction to the flexibility in the machine direction is in the range of 4:1 to 1:2.

14. The method as recited in claim 11, further comprising applying a hot-setting adhesive layer is applied to the nonwoven layer in such a quantity that represents at least 10% of a base material composed of the nonwoven and the binder.

15. The method as recited in claim 14, wherein the base material includes flame retardant agents, water repellent agents, and/or oil repellent agents.
